(19) United States
(12) Patent Application Publication
(10) Pub. No.: US 2015/0363348 A1
(43) Pub. Date: Dec. 17, 2015

(54) AUTOMOBILE ADAPTOR SYSTEM, APPARATUS AND METHODOLOGY

(71) Applicant: Timothy Allen Deratany, Miramar, FL (US)

(72) Inventor: Timothy Allen Deratany, Miramar, FL (US)

(21) Appl. No.: 14/737,321

(22) Filed: Jun. 11, 2015

Related U.S. Application Data
(60) Provisional application No. 62/010,971, filed on Jun. 11, 2014.

(51) Int. Cl. G06F 13/40; G06F 1/16

(52) U.S. Cl. CPC G06F 13/4081; G06F 1/1632

(57) ABSTRACT

An adapter for an electronic device usable in an automobile. The adapter includes a master dock with a port for a device-specific interface, and a device plug. The master dock interfaces with the automobile through an electronic communication connection, for example, USB. The master dock receives the device-specific interface to allow use of the adapter with various electronic devices. For example, device-specific interfaces may be provided for iPhones, Android phones, Windows phones, iPads, Nexus tablets, or virtually any other mobile electronic device. The device-specific interface receives the electronic device via a properly-positioned port, which connects the electronic device via the master dock to charging and/or data communication ports without use of a cable cord. Concomitantly, the automobile or vehicle has a variety of screens and/or consoles through which the user can view information from a smart phone, tablet or like device through said adaptor. Further, the windows of the vehicle, as well as the screens/consoles may incorporate therein or thereon touchscreen capability, whereby the user can interact, such as through the Internet or other network, to remote material and other users

### CROSS REFERENCE TO RELATED APPLICATION

The present invention claims priority to U.S. Provisional Patent Application No. 62/010,971, filed Jun. 11, 2014, the contents of which are incorporated herein in their entirety by reference.

### FIELD OF THE INVENTION

The present invention is directed to improvements in the integration of consumer electronics in automobiles, and vehicular interfaces for same.

### BACKGROUND OF THE INVENTION

The use of mobile devices, such as smart phones, has grown exponentially over the last decade, and is expected to become ubiquitous for virtually all humans in due course. Concomitant with the growth of mobile phones is the increase in electronics and telematics in vehicles and other moving devices, such as automobiles, trucks, motorcycles, etc.

With the growing sophistication of the users and the desire to network with other devices, users now wish to interface with these other devices and control them, e.g., through a smart phone. Naturally, with the automobile being a fixation among virtually all humans, those people with smart phones want to network and interface with their vehicles, interacting with them while driving and generally.

There is, of course, prior art showing the usage of various telematics devices in vehicles, including radios, displays, televisions, and so forth. More recent cars have consoles with digital displays that illustrate various car functions, and there are prior art materials addressing the usage and interactivity of a variety of devices with an automobile. All of these techniques, however, rely on complicated structural and telematic interconnectivity, and do not focus on the integration of smart phones or other devices in conjunction with vehicles, providing a simplified and more comprehensive interface.

There is, therefore, a present need to provide an improved technique and apparatus to better integrate a smart phone or other mobile device to an automobile or other vehicle display platform.

There is also a need to leverage the advantages of a smart phone or tablet to various occupants within a vehicle, providing respective screens therein, whereby a viewer can access the Internet separately and interact with the display, such as via a touch screen.

The present invention is directed to making these improved techniques and apparatuses simple to use, inexpensive, accurate and adaptable for use by multiple users having diverse equipment and interconnection standards.

### SUMMARY OF THE PRESENT INVENTION

The invention generally relates to an adapter for an electronic device usable in an automobile with improved interface capability. The adapter may include a master dock or port, a device-specific interface, and a connector or plug. The master dock may interface with the automobile through an electronic communication connection, for example, USB or other protocol. The master dock receives the device-specific interface to allow use of the adapter with various electronic devices, for example, device-specific interfaces for iPhones, Android phones, Windows phones, iPads, Nexus tablets, or virtually any other mobile electronic device. The device-specific interface receives the electronic device via a properly-positioned device port, which may connect to the electronic device via the charging and/or data communication port without use of a cable cord. Concomitantly, the automobile or vehicle has a variety of screens and/or consoles through which the user can view information from a smart phone, tablet or like device through said adaptor. Further, the windows of the vehicle, as well as the screens/consoles may incorporate therein or thereon touchscreen capability, whereby the user can interact, such as through the Internet or other network, to remote material and other users.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying DRAWINGS, where like reference numerals designate like structural and other elements, in which:

FIG. 1 is a representative view of an embodiment of a device configuration incorporating the principles of the present invention with exemplary functioning illustrated; and

FIG. 2 is a representative view of an adaptor device and configuration pursuant to the teachings of the present invention.

### DETAILED DESCRIPTION OF THE PRESENT INVENTION

The present invention will now be described more fully hereinafter with reference to the accompanying DRAWINGS, in which preferred embodiments of the invention are shown. It is, of course, understood that this invention may, however, be embodied in many different forms and should not be construed as limited to the embodiments set forth herein; rather, these embodiments are provided so that the disclosure will be thorough and complete, and will fully convey the scope of the invention to those skilled in the art. It is, therefore, to be understood that other embodiments can be utilized and structural changes can be made without departing from the scope of the present invention.

The present invention is generally directed to improved apparatuses, systems, processes and techniques for smart phone or mobile usage by individuals with their automobiles and other vehicles, and particularly to an adaptor configuration for so interconnecting the mobile to the vehicle, as well as enhanced capabilities of the user to interface through displays and consoles within the vehicle.

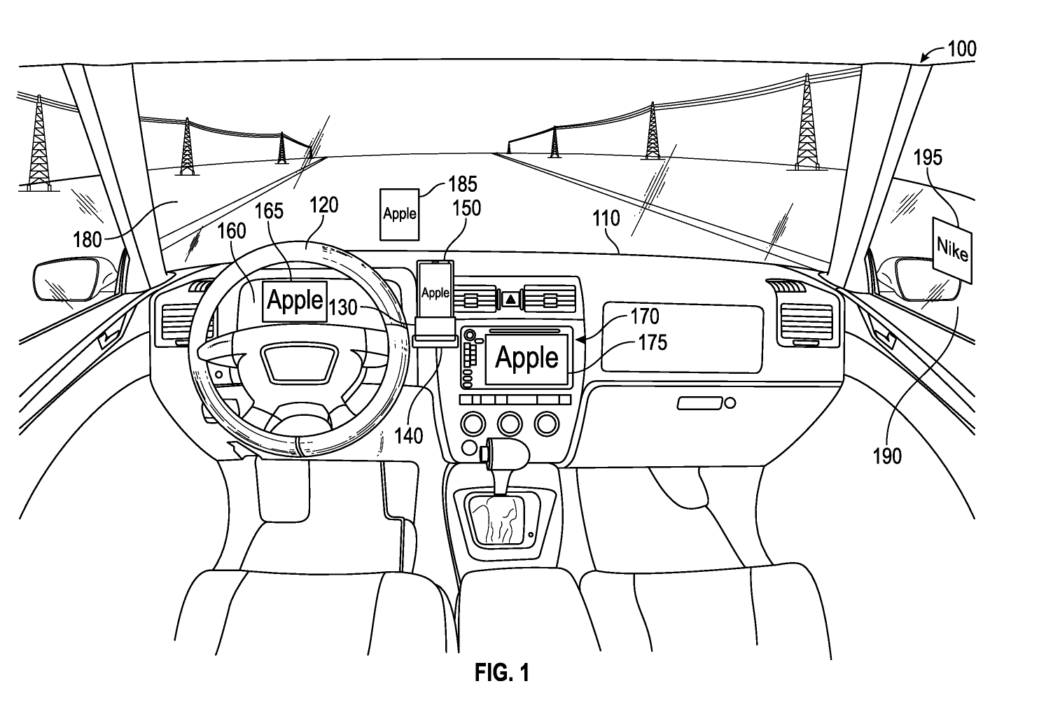

With reference now to FIG. 1 of the DRAWINGS, there is illustrated a representative configuration of an automobile interior, generally designated by the reference numeral 100, that includes the aforesaid adaptor assembly and interfaces configurations pursuant to the present invention. As mentioned, the present invention in one embodiment generally relates to an adapter for an electronic device usable in an automobile or other vehicle, generally designated by the reference numeral 110.

As shown, the vehicle or car 110 has a steering wheel, generally designated by the reference numeral 120. As also shown, a car holster, generally illustrated, described and designated by the reference numeral 130, receives a smart phone, tablet or other mobile device, generally designated by the reference numeral 150 within the holster 130. The automobile in this embodiment includes interconnectivity, as generally described and designated by the reference numeral 140, to the so-inserted smart phone or other device, as described in more detail hereinbelow. The holster 130 is preferably configured similar to a belt or other human-portable holster, making the usage of the holster more familiar to the user. As shown illustrated, exemplary text is displayed on the smart device 150, i.e., the word APPLE.

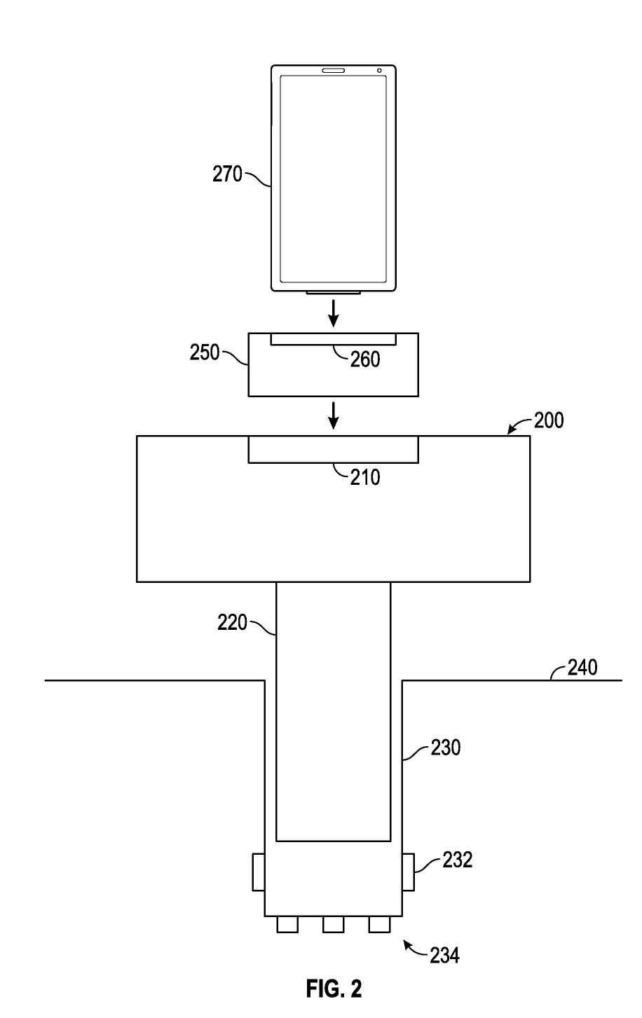

Furthermore, the aforesaid holster 130 includes additional functionality than as a mere receptacle or container, including charging capability and connectivity, generally described hereinbelow in connection with FIG. 2, which can include a USB/phone charger port and other linkages, as are understood to one of skill in the art. Additionally, the holster 130 can include further interfunctionality to accommodate different and/or additional mobile phones and other equipment and devices, as is understood in the art.

As further illustrated in FIG. 1, the car 110 has a projection area, generally designated by the reference numeral 160, whereby images and text may be displayed, such as the various car function data, e.g., speed and fuel status. With the instant invention, however, and with the mobile device or smart phone 150 interconnected to the car 110, e.g., via the holster 130, other data may be projected onto the projection area 160, such as on a screen or window therein, generally described and designated by the reference numeral 165. As illustrated, a variety of other data may be so projected, including GPS or other location data or maps, phone calls and data, such as may originate from the device 150 and everything to which it connects, regarding said calls, social networking information and images, and a host of other potential data and images, as may be found on the Internet or elsewhere. Accordingly, the screen 165 may display information originating from the smart phone or tablet or other device 150, which could originate from the Internet or somewhere external to the car 110, such as the word APPLE also shown on the smart device 150, as described hereinabove.

It should, therefore, be understood that the interconnectivity 140 provides the interface for the smart phone or other device 150 to interact with the automobile, motor cycle or other vehicle 110, providing an integration of the smart phone 150 into the automobile's 110 electronics environment, whereby the user can govern or control aspects of the automobile through the device, particularly access to the outside world, i.e., external to the car, via connection to the Internet, downloading files, music, movies, etc. therefrom, and telephone calls, whether voice or video versions. The interface 140 for this interconnectivity has the requisite technical capability to manage the various data types and capacities thereof, pursuant to the numerous IEEE and other technical standards, as are understood in the art.

The car 110 preferably also includes a console, generally designated by the reference numeral 170, preferably having a touch screen interactive display, generally designated by the reference numeral 175, which may include the various car-related functionalities, such as air conditioning, radio and other console controls. It should be understood that the console 170 is preferably on the dash of the vehicle 110 for easy viewing, as shown in FIG. 1. With the mobile device 150 interconnected, via the aforesaid holster 130, the content on the display of the mobile device can be mirrored on said console 170, and also on the aforesaid display 165, along with the interactivity functionalities. Further, the images on the mobile device 150, which are small and with text in small font, unsuitable for viewing while driving, may be magnified when displayed on the console 170, as generally illustrated. Accordingly, just as with screen 165 and the screens described in more detail hereinbelow, screen 175 displays information originating from the smart phone or tablet or other device 150 which could originate from the Internet or somewhere external to the car 110, such as the word APPLE which is also magnified for ease of viewing, especially while driving.

With further reference to FIG. 1, the automobile 110 has a windshield, generally designated by the reference numeral 180. The instant invention includes interconnectivity of the aforesaid smart phone 150 to the vehicle 110 through another touch screen interactive display, generally designated by the reference numeral 185, on or within the aforesaid windshield 180. It should, of course, be understood that the screen 185, being on the windshield 180, should not impair the driver's vision, and be sufficiently transparent whether or not in use. Nonetheless, the modality and functionality of the screen 185 may enable the driver to interact with the phone 150 through the screen 185, whether in the same manner as with the screens 165 and 175, or reduced capability. As discussed hereinabove, the images from the smart device 150 may be displayed, e.g., on a touch screen 185, or projected onto the space 185, as is understood in the art, as shown by the word APPLE. It should, of course, be understood that the use of the word APPLE is emblematic of the words, phrases, text, images, videos, movies and other media that may be duplicated from the smart device 150

In any event, through proper usage, such as the overlays in airplane cockpits, and otherwise, the driver can interact with the screen 185 while maintaining vision on the road ahead, i.e., less distraction than turning the head downward or away from the road. As with steering wheel commands, in time, the use of these functions will become second nature to the driver, and can become more tactile than visual, and be performed with minimal distraction. Accordingly, the FCC and other authorities should not have difficulties with the present invention.

It should be understood that the screen 185 may encompass a small section of the windshield 180, as shown, or a larger proportion thereof. For example, touch screen capability may be limited to a particular range 185, thereby conserving cost and minimizing potential vision impairment. However, there could be multiple screens 185, with one on the passenger side that has the same or different capabilities. In this fashion, the passenger may have a full-range of the functionalities, and the driver a restricted or limited range to reduce distraction possibilities. Nonetheless, when the car 110 is not in motion, the full driver-side capabilities can be released, thereby allowing the driver to access the Internet, call a friend, etc., the visual component of which is displayed within the screen 185. It should be understood that if the driver is so engaged and the car resumes motion, the screen 185 should slowly go transparent, perhaps keeping the vocal or auditory components.

With further reference to FIG. 1 of the DRAWINGS, the car or vehicle 110 has other windows, each of which could incorporate the features of the present invention. For example, a side door is shown with a passenger-side window, generally designated by the reference numeral 190, and including another touch screen interactive display or screen, generally designated by the reference numeral 195 therein or thereon. As discussed hereinabove, the passenger may thus interact with the screen 195 to access the web, phone a friend or otherwise use the telecommunications capabilities of the instant invention. A similar screen 195 may be on the driver's side window, although the driver's side may include more automobile functionalities for ease of reference, such as fuel status, engine temperature, tire pressures, etc., as well as graphics on the averages and statistics for the usage, as is understood in the art. As illustrated in FIG. 1, the passenger screen 195 has different content thereon, particularly the word NIKE, demonstrating the multi-user capabilities of the present invention.

It should be further understood that the aforementioned interconnectivity capabilities of the screens 185 and 195 for the windshield 180 and window 190, can also be employed on the remaining passenger windows, and also perhaps on the rear window. The screen 195 for backseat drivers may thus contain the ability to play games, watch movies, access the Internet, and perform other functions, e.g., the capability of the car 110 may be enhanced by an app download, enabling all or one screen to have that functionality, e.g., playing a game of chess. In this fashion, everyone in the vehicle has access to the Internet and diversion, although the driver's accessibility should be circumscribed to prevent distraction.

In any event, although many of the screens portray the same image, it should be understood that the various screens may display alternate images, as befitting multiple independent users, a default image, or be blank, e.g., powered off or on standby until screen activation. Thus, a lone driver would have screens 165, 175 and 185 in front of them, and perhaps have access, while driving, to a screen 195 on the driver's side window. The other screens, however, would not be of used and would be turned off. Further, any one or any combination of the screens can be operational at the same time, subject to the aforesaid driver constraints. It should be understood that the driver may wish to minimize the information availability (and distraction) and rely on one screen for information, such as screen 165, turning screens 175, 185 and 195 off or otherwise deactivating them, which may countermand all other vehicle occupants' usages. Thus, children can manipulate their screens 195 in the back seat while the car is parked and all other screens are off, e.g., off battery power.

It should be understood that although the screens illustrated are rectilinear in configuration, other shapes are possible, such as circles, ovals, etc.

It should be understood that additional functionalities than those set forth in FIG. 1 are encompassed by the instant invention and within the scope of the present invention.

With reference now to FIG. 2 of the DRAWINGS, there is shown a preferred adaptor embodiment of the present invention, generally designated by the reference numeral 200. The adapter 200 preferably includes a master dock or port, generally designated by the reference numeral 210, preferably at an end of said adaptor 200, and a plug or insertion means, generally designated by the reference numeral 220, preferably at an opposite end of said adaptor 200, as illustrated in FIG. 2. It should, of course, be understood that the plug 220 engages or interfaces a vehicle port, generally designated by the reference numeral 230, physically and electronically connecting to the vehicle or automobile, generally designated by the reference numeral 240. It should be understood that that the master dock 210 interfaces with the automobile 240 through an electronic communication connection, for example, USB. Thus, the adaptor 200 when fully inserted into and engaged within the vehicle port 230, preferably connects to a power source and connects to communication with the various equipment and functionalities within the vehicle 240, including the dash and other displays available to the user, as described in more detail hereinabove and hereinbelow.

Additionally, there is shown a device-specific adaptor, generally designated by the reference numeral 250, which is configured at one end to physically and electronically engage within said master dock 210, and preferably at the opposite end have a receiving port, generally designated by the reference numeral 260, within which to physically and electronically engage an external device, such as a particular mobile phone for this device-specific adaptor 250, generally designated by the reference numeral 270, through a plug or insertion means, as is described hereinabove and understood in the art.

Thus, in operation, the master dock 210 within the adaptor 200 receives the aforesaid device-specific adaptor 250 therein to allow use of the adapter 200 with various electronic devices 270, as is understood in the art. For example, device-specific adaptors 250 may be provided for iPhones, Android phones, Windows phones, iPads, Nexus tablets, or virtually any other mobile electronic device, which when inserted into the master dock 210 provide the requisite interconnectivity for the particular device 270 to communicate to the automobile or vehicular 240 electronics.

Thus, through the use of an appropriate device specific adaptor 250, one or more of the exemplary electronic devices 270, via a properly-positioned device plug 280, may connect the electronic device 270 ultimately to the charging and/or data communication port 230, preferably without use of a cable cord. The master dock 210 is preferably mounted within the automobile 240 at a position accessible to the driver, which, as illustrated in FIG. 1, is fixed onto the dash next to the steering wheel 120. It should be understood, however, that the master dock 210 may be mounted elsewhere. It should also be understood that the master dock 210 and/or the device-specific adaptors 250 may swivel, rotate, or otherwise be manipulated by a user, e.g., a driver or passenger. The adapter 200 may additionally increase a cell phone signal received by the electronic device.

It should be understood that the aforementioned adapter system 200 may be a feature offered by one or more automakers. With this configuration, a user may take their electronic device 270 out of a belt holder or case, and slide the device 270 easily into a slot or holster 140, as described, which provides the requisite electronic and power connectivity for the device 270, preferably without the use of a connectivity or power cord for manipulation by the user. The connectivity of the instant invention is preferably immediate upon inserting the master dock 210 into the slot or port 230. It should, of course, be understood that the aforesaid interconnectivity between the device 270 and the vehicle 240 may be wireline, wireless or a combination thereof.

With reference again to FIGS. 1 and 2 of the DRAWINGS, once an electronic device 150/270 connects to the adaptor 200 of the present invention, the connected device 150/270 may recharge its battery 127, e.g., through power connectors, generally designated by the reference numeral 232, provide communication within the automobile 110/240, through the aforementioned interconnectivity means, generally designated by the reference numeral 234, and facilitate hands-free operations, e.g., via visual displays in the aforementioned projection area or screen 165, the console screen 175, and window screens 185 and 195, as described in more detail hereinabove. It should, of course, be understood that a software application or applications may be installed on the device 150/270 or updated by the phone OS provider to enable better or alternate data communication with the automobile 110/240 and allow cellular transmission services.

As discussed, the screen of the connected electronic device 150/270 is generally small and may be mirrored on the projection area screen 165, the console screen or display 175, and/or the screens 185 and 195 of the automobile 110/240, such as a navigation console, A/V system, heads-up display, windshield projected display, or other display on the automobile 110/240. As also discussed, the electronic communication connection can offer additional features, such as screen magnification, transmission of audio and video signals (music, notifications, calls, navigation, etc.). The present invention may further include a microphone to enable hands-free calling from the connected electronic device.

It should also be understood that the different data/information transmitted from the electronic device 150/270 to the automobile 110/240 may be displayed on various automobile displays. For example, the screen of the electronic device may be mirrored on the automobile's console display 175, and allow the user to interact on the console screen 175 rather than having to use the phone's 150 smaller screen. Meanwhile, data/information could be transmitted to the aforesaid screen 185, which could be a windshield-projected display, e.g., showing information about a song playing through the adapter 200, caller ID, schedule reminders, SMS text messaging, news, sports, social network updates, advertisements, weather, local event alerts, traffic reports, entertainment alerts, and other such data/information, as is understood in the art. Accordingly, the windshield projection feature 185 of the present invention can display information on a car windshield that originates from a cell phone, tablet device, and ultimately from the Internet or private source.

It should also be understood that the vehicle may employ the Operating System of the smart phone or other device interconnected through the interface 140, for example, in screen magnification, as depicted in FIG. 1.

The previous descriptions are of preferred embodiments for implementing the invention, and the scope of the invention should not necessarily be limited by these descriptions. It should be understood that all articles, references and citations recited herein are expressly incorporated by reference in their entirety. The scope of the current invention is defined by the following claims.

What is claimed is:

1. A smart device adapter for installation in a vehicle comprising:
a master dock, said master dock having a device port configured to receive therein an electronic device;
a device plug, said device plug configured to interface with a port of a vehicle,
wherein said electronic device communicates with the vehicle via the adapter, and
wherein signals from said electronic device are sent to said vehicle, part of the communication being displayed on a screen within the vehicle.

2. The smart phone adaptor according to claim 1, further comprising:
a device-specific adaptor, said device-specific adaptor configured to interface said master dock within said device port and configured to receive said electronic device.

3. The smart phone adaptor according to claim 2, wherein said device-specific adaptor is configured for a device selected from the group consisting of iPhones, Android phones, Windows phones, iPads, Nexus tablets, and any other mobile electronic device.

4. The smart phone adaptor according to claim 1, wherein said signals from said electronic device are displayed on a plurality of screens within said vehicle.

5. A vehicle with smart device accessibility comprising:
a smart adaptor having a device port configured to receive therein an electronic device, and having a plug configured to interface with said vehicle; and
at least one screen within the vehicle,
wherein said electronic device in said smart adaptor communicates with the vehicle, and
wherein signals from said electronic device are sent to said vehicle, a portion of said signals being displayed on said at least one screen.

6. The vehicle according to claim 5, further comprising:
a device-specific adaptor, said device-specific adaptor configured to interface said smart adaptor within said device port and configured to receive said electronic device.

7. The vehicle according to claim 6, wherein said device-specific adaptor is configured for a device selected from the group consisting of iPhones, Android phones, Windows phones, iPads, Nexus tablets, and any other mobile electronic device

8. The vehicle according to claim 5, wherein said signals from said electronic device are displayed on a plurality of screens within said vehicle.

9. The vehicle according to claim 5, wherein said signals from said electronic device are displayed on at least one screen on a projection area within said vehicle.

10. The vehicle according to claim 5, wherein said signals from said electronic device are displayed on at least one screen on a console area within said vehicle.

11. The vehicle according to claim 5, wherein said signals from said electronic device are displayed on at least one screen on a windshield area within said vehicle.

12. The vehicle according to claim 5, wherein said signals from said electronic device are displayed on at least one screen on an interior window of said vehicle.

13. The vehicle according to claim 12, wherein said interior window is selected from the group consisting of passenger side windshield, passenger side window, backseat passenger windows and rear window.

14. The vehicle according to claim 5, wherein said signals from said electronic device comprise audio and/or visual signals which are performed on said at least one screen.
